(19) United States
(12) Patent Application Publication
(10) Pub. No.: US 2009/0252328 A1
(43) Pub. Date: Oct. 8, 2009

(54) SYSTEM FOR SECURELY TRANSMITTING MTA CONFIGURATION FILES

(75) Inventor: CHUN-CHIEH LAI, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/193,773

(22) Filed: Aug. 19, 2008

(30) Foreign Application Priority Data
Apr. 8, 2008 (CN) 200810300869.2

(51) Int. Cl. H04L 9/08

(52) U.S. Cl. 380/278

(57) ABSTRACT

A system for securely transmitting configuration files from a server to a terminal device includes a downloading module, an encrypting module, a signing module, a transmitting module, a transceiver module, a verifying module, and a decrypting module. The downloading module downloads a first configuration file of the terminal device including a sign public key from the server upon the condition that the terminal device is powered on and activates the server to transmit a second configuration file of the terminal device. The encrypting module retrieves and encrypts the second configuration file. The signing module retrieves a sign private key to sign the encrypted second configuration file. The transmitting module transmits the signed second configuration file to the transceiver module. The verifying module retrieves the sign public key to verify the signed second configuration file. The decrypting module decrypts the verified second configuration file to retrieve the second configuration file.

### BACKGROUND

1. Field of the Invention

Embodiments of the present disclosure relate to cable transmissions and, particularly, to a system and method for transmitting MTA configuration files.

2. Description of related art

Multimedia terminal adapters (MTA) are key elements in voice over internet protocol (VoIP) transmissions for executing media processing (for example, sampling and encoding/decoding), packets encapsulation (such as encrypting), and signaling protocols.

The MTAs download configuration files from a trivial file transfer protocol (TFTP) server when being powered on. The configuration files may include important and confidential information, such as user names and passwords, which should be securely transmitted. According to the MTA provisioning basic flow of the PacketCable, the configuration files are transmitted on a network without encryption. If the configuration files need to be transmitted securely, the MTA provisioning secure flow of the PacketCable needs to be executed. However, the MTA provisioning secure flow needs to build a key distribution center (KDC) server, which increases costs and complicates the processes.

### SUMMARY

A system for securely transmitting configuration files from a server to a terminal device includes a downloading module, an encrypting module, a signing module, a transmitting module, a transceiver module, a verifying module, and a decrypting module. The downloading module is configured for downloading a first configuration file of the terminal device from the server upon the condition that the terminal device is powered on, and activating the server to transmit a second configuration file of the terminal device, and the first configuration file includes a sign public key. The encrypting module is configured for retrieving and encrypting the second configuration file; a signing module configured for retrieving a sign private key and signing the encrypted second configuration file with the sign private key. The transmitting module is configured for transmitting the signed second configuration file. The transceiver module is configured for receiving the signed second configuration file. The verifying module is configured for retrieving the sign public key from the first configuration file and verifying the signed second configuration file with the sign public key. The decrypting module configured for decrypting the verified second configuration file to retrieve the second configuration file.

Other advantages and novel features will become more apparent from the following detailed description when taken in conjunction with the accompanying drawings:

### BRIEF DESCRIPTION OF THE DRAWINGS

FIG. 1 is a schematic diagram of a transmission system for transmitting MTA configuration files according to one embodiment of the present disclosure;

FIG. 2 is a schematic diagram of an encrypted configuration file of another embodiment of the present disclosure;

FIG. 3 is a flowchart of a transmission method for MTA configuration files of a third embodiment of the present disclosure;

FIG. 4 is a flowchart of a transmission method for MTA configuration files of a fourth embodiment of the present disclosure; and

FIG. 5 is a flowchart of a transmission method for MTA configuration files of a fifth embodiment of the present disclosure.

### DETAILED DESCRIPTION OF CERTAIN INVENTIVE EMBODIMENTS

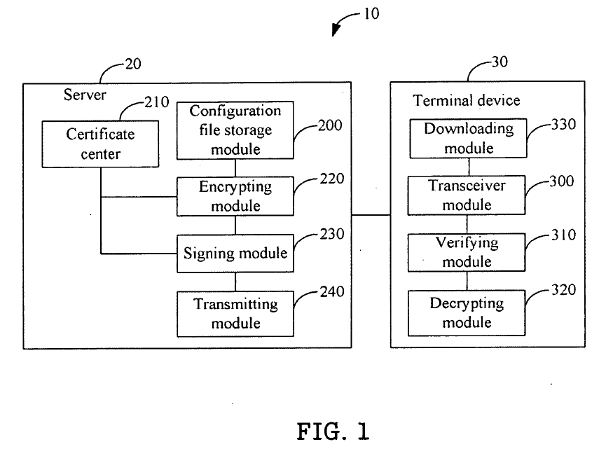

FIG. 1 is a schematic diagram of a transmission system 10 for transmitting MTA configuration files according to one embodiment of the present disclosure. In one embodiment, the transmission system 10 includes a server 20 and a terminal device 30. The transmission system 10 securely transmits configuration files from the server 20 to the terminal device 30. The server 20 stores configuration files of the terminal device 30. When powered on, the terminal device 30 begins to download configuration files from the server 20, then the server 20 encrypts and signs the configuration files before transmitting to prevent the configuration files from being breached during transmission on a network to ensure the security of the configuration files. The terminal device 30 decrypts and verifies the encrypted and signed configuration files upon receiving them.

In one embodiment, the server 20 may be a trivial file transfer protocol (TFTP) server, while the terminal device 30 may be a cable modem integrating functions of a multimedia terminal adapter (MTA). The configuration files of the terminal device 30 include a first configuration file (i.e., the cable modem configuration file), and a second configuration file (i.e., the original MTA configuration file). In alternative embodiments, the configuration files may be other configuration files corresponding to different terminal devices. When powered on, the terminal device 30 initially downloads the first configuration file from the server 20, which can be transmitted without being encrypted, and then activates the server 20 to transmit the second configuration file. The server 20 encrypts and signs the second configuration file before transmitting it to the terminal device 30.

The server 20 includes an encrypting module 220, a signing module 230, and a transmitting module 240. The encrypting module 220 is configured for retrieving the second configuration file of the terminal device 30 and encrypting the second configuration file. The signing module 230 is configured for retrieving a sign private key and signing the encrypted second configuration file with the sign private key. In one embodiment, the signing module 230 signs the encrypted second configuration file according to the Ronald Rivest, Adi Shamir, Leonard Adleman (RAS) algorithm. The transmitting module 240 is configured for transmitting the signed second configuration file to the terminal device 30.

The server 20 further includes a configuration file storage module 200 and a certificate center 210. The configuration file storage module 200 is configured for storing the configuration files of the terminal device 30 and, specifically, the first configuration file and the second configuration file in one exemplary embodiment. The first configuration file includes a sign public key corresponding to the sign private key. The encrypting module 220 retrieves the second configuration file from the configuration file storage module 200. The certificate center 210 is configured for storing keys for encrypting and signing, including private and public keys. The sign public key in the first configuration file is retrieved from the certificate center 210, and the signing module 230 also retrieves the sign private key from the certificate center 210.

The terminal device 30 includes a transceiver module 300, a verifying module 310, a decrypting module 320, and a downloading module 330. The downloading module 330 is configured for downloading the first configuration file from the server 20 and activating the server 20 to transmit the second configuration file when the terminal device 30 is powered on. In one embodiment, the downloading module 330 initially downloads the first configuration file, and after the first configuration file has been successfully downloaded to the terminal device 30, activates the server 20 to transmit the second configuration file to the terminal device 30 by sending a downloading signal to the server 20. The transceiver module 300 is configured for receiving the signed second configuration file from the server 20. The verifying module 310 is configured for retrieving the sign public key from the first configuration file and verifying the received second configuration file with the sign public key to determine if the received second configuration file is from the server 20. If the received second configuration file does not pass the verification, the verifying module 310 discards the received second configuration file. The decrypting module 320 is configured for decrypting the verified second configuration file to retrieve the second configuration file.

In one embodiment, the encrypting module 220 encrypts the second configuration file with a random key according to a symmetric algorithm. An encryption key and a decryption key of the symmetric algorithm are the same, therefore, the random key from the symmetric algorithm should be inserted into the second configuration file to transmit to the terminal device 30 for decrypting.

The encrypting module 220 is further configured for retrieving an encryption public key, encrypting the random key with the encryption public key according to an asymmetric algorithm, and inserting the encrypted random key into the encrypted second configuration file to form a third configuration file. In one embodiment, the symmetric algorithm is an advanced encryption standard (AES) algorithm, the encrypting module 220 encrypts a random key and a random initialization vector of the AES algorithm, and inserts the encrypted random key and random initialization vector into the encrypted second configuration file to form the third configuration file. The random key and the random initialization vector are both 128 bits. In alternative embodiments, the encrypting module 220 encrypts the second configuration file according to other symmetric algorithms or asymmetric algorithms. The asymmetric algorithm is the RSA algorithm. The encrypting module 220 retrieves an encryption public key of the RSA algorithm for encrypting. The terminal device 30 retrieves an encryption private key of the RSA algorithm for decrypting. In one exemplary embodiment, the encryption public key is 1024 bits. In alternative embodiments, the encrypting module 220 encrypts the random key of the symmetric algorithm according to other asymmetric algorithms.

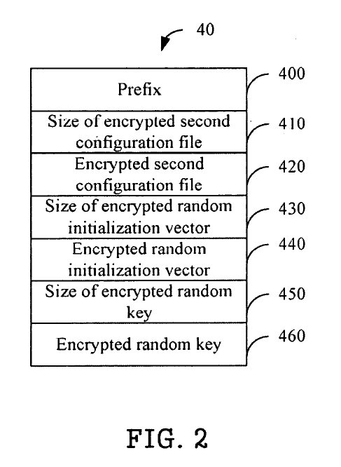

In one embodiment, a structure of the third configuration file 40 is shown in FIG. 2. The third configuration file 40 includes a prefix 400, a size of the encrypted second configuration file 410, the encrypted second configuration file 420, a size of the encrypted random initialization vector of the AES algorithm 430, the encrypted random initialization vector 440, a size of the encrypted random key of the AES algorithm 450, and the encrypted random key 460.

The verifying module 310 verifies the signed second configuration file to retrieve the third configuration file. In the terminal device 30, the decrypting module 320 first decrypts the encrypted random key in the third configuration file with the encryption private key of the asymmetric algorithm to retrieve the random key of the symmetric algorithm, and then decrypts the encrypted second configuration file in the third configuration file with the random key to retrieve the second configuration file. In one embodiment, the decrypting module 320 decrypts the encrypted random key and random initialization vector of the AES algorithm with the encryption private key of the RSA algorithm, to retrieve the random key and the random initialization vector for decrypting the encrypted second configuration file.

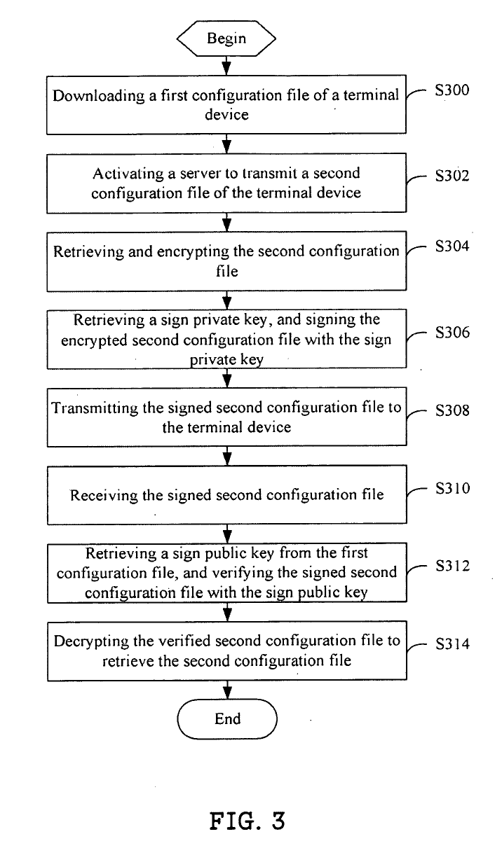

FIG. 3 is a flowchart of a transmission method for securely transmitting MTA configuration files of one embodiment of the present disclosure. In block S300, the terminal device 30 is powered on, and the downloading module 330 downloads a first configuration file of the terminal device 30 from the server 20. The first configuration file includes a sign public key. In block S302, the downloading module 330 activates the server 20 to transmit a second configuration file of the terminal device 30 after the downloading of the first configuration file is finished. In block S304, the encrypting module 220 of the server 20 retrieves the second configuration file from the configuration file storage module 200 and encrypts the second configuration file. In block S306, the signing module 230 retrieves a sign private key from the certificate center 200 and signs the encrypted second configuration file with the sign private key. In block S308, the transmitting module 240 transmits the signed second configuration file to the terminal device 30.

In block S310, the transceiver module 300 of the terminal device 30 retrieves the signed second configuration file. In block S312, the verifying module 310 retrieves the sign public key from the first configuration file and verifies the signed second configuration file with the sign public key. In block S314, the decrypting module 320 decrypts the verified second configuration file to retrieve the second configuration file.

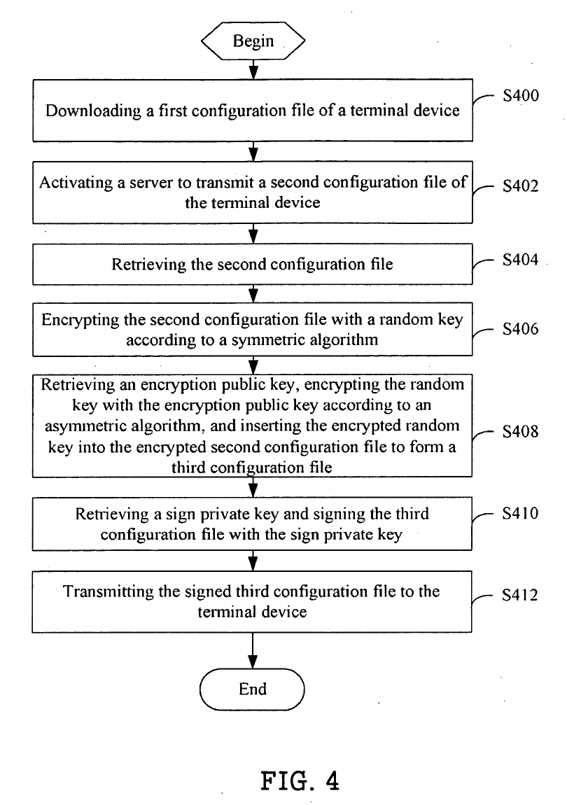

FIG. 4 is a flowchart of a transmission method for securely transmitting MTA configuration files of another embodiment of the present disclosure. In block S400, the terminal device 30 is powered on and the downloading module 330 downloads a first configuration file of the terminal device 30 from the server 20. The first configuration file includes a sign public key. In block S402, the downloading module 330 activates the server 20 to transmit a second configuration file of the terminal device 30 after the downloading of the first configuration file is finished. In block S404, the encrypting module 220 of the server 20 retrieves the second configuration file from the configuration file storage module 200.

In block S406, the encrypting module 220 encrypts the second configuration file with a random key according to a symmetric algorithm. In block S408, the encrypting module 220 retrieves an encryption public key from the certificate center 210, encrypts the random key with the encryption public key according to an asymmetric algorithm, and inserts the encrypted random key into the encrypted second configuration file to form a third configuration file. In the exemplary embodiment, the symmetric algorithm is the AES algorithm further including a random initialization vector, and the encrypting module 220 further encrypts the random initialization vector and inserts the encrypted random initialization vector into the encrypted second configuration file. The asymmetric algorithm is the RSA algorithm. In block S410, the signing module 230 retrieves a sign private key from the certificate center 200 and signs the third configuration file with the sign private key. In block S412, the transmitting module 240 transmits the signed third configuration file to the terminal device 30.

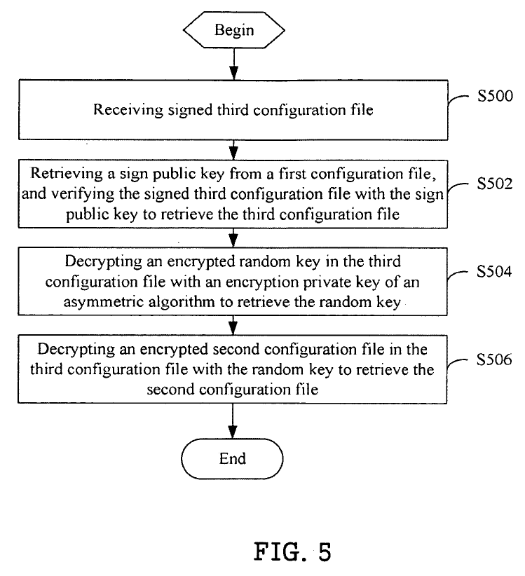

FIG. 5 is a flowchart of a transmission method for securely transmitting MTA configuration files of a fifth embodiment of the present disclosure. In block S500, the transceiver module 300 receives the signed third configuration file. In block S502, the verifying module 310 retrieves the sign public key from the first configuration file of the terminal device 30, and verifies the signed third configuration file with the sign public key to retrieve the third configuration file. In block S504, the decrypting module 320 decrypts the encrypted random key in the third configuration file with an encryption private key of the asymmetric algorithm to retrieve the random key. In one exemplary embodiment, the asymmetric algorithm is the RSA algorithm, the symmetric algorithm is the AES algorithm, and the decrypting module 320 further decrypts the encrypted random initialization vector in the third configuration file. In block S506, the decrypting module 320 decrypts the encrypted second configuration file in the third configuration file with the random key to retrieve the second configuration file. In the exemplary embodiment, the decrypting module 320 decrypts the encrypted second configuration file with the random key and the random initialization vector of the AES algorithm.

The foregoing transmission system encrypts and signs the second configuration file, ie, the MTA configuration file, before transmitting to ensure the security of the second configuration file, thereby preventing the second configuration file from being breached during transmission. As this is accomplished without building additional devices, the costs are decreased.

The foregoing disclosure of various embodiments has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto and their equivalents.

What is claimed is:

1. A system for securely transmitting configuration files from a server to a terminal device, the system comprising:
a downloading module configured for downloading a first configuration file of the terminal device from the server upon the condition that the terminal device is powered on, and activating the server to transmit a second configuration file of the terminal device, the first configuration file comprising a sign public key;
an encrypting module configured for retrieving and encrypting the second configuration file;
a signing module configured for retrieving a sign private key and signing the encrypted second configuration file with the sign private key;
a transmitting module configured for transmitting the signed second configuration file;
a transceiver module configured for receiving the signed second configuration file;
a verifying module configured for retrieving the sign public key from the first configuration file and verifying the signed second configuration file with the sign public key; and
a decrypting module configured for decrypting the verified second configuration file to retrieve the second configuration file.

2. The system of claim 1, wherein the server comprises the encrypting module, the signing module and the transmitting module, and the terminal device comprises the downloading module, the transceiver module, the verifying module, and the decrypting module.

3. The system of claim 2, wherein the server further comprises a configuration file storage module configured for storing the first configuration file and the second configuration file of the terminal device.

4. The system of claim 2, wherein the server further comprises a certificate center configured for storing the sign private key and the sign public key.

5. The system of claim 1, wherein the signing module signs the encrypted second configuration file according to an asymmetric algorithm.

6. The system of claim 1, wherein the encrypting module encrypts the second configuration file with a random key according to a symmetric algorithm.

7. The system of claim 6, wherein the encrypting module is further configured for retrieving an encryption public key and encrypting the random key with the encryption public key according to an asymmetric algorithm, and inserting the encrypted random key into the encrypted second configuration file to form a third configuration file.

8. The system of claim 7, wherein the verifying module verifies the signed second configuration file to retrieve the third configuration file.

9. The system of claim 8, wherein the decrypting module decrypts the encrypted random key in the third configuration file with an encryption private key according to the asymmetric algorithm to retrieve the random key, and decrypts the encrypted second configuration file in the third configuration file with the random key of the symmetric algorithm.

10. The system of claim 9, wherein the symmetric algorithm is the AES algorithm, and the encrypting module is further configured for encrypting a random initialization vector of the AES algorithm with the encryption public key according to the asymmetric algorithm, and inserting the encrypted random initialization vector into the encrypted second configuration file.

11. The system of claim 10, wherein the decrypting module decrypts the encrypted random key and random initialization vector in the third configuration file with the encryption private key according to the asymmetric algorithm to retrieve the random key and the random initialization vector, and decrypts the encrypted second configuration file in the third configuration file with the random key and the random initialization vector.

12. The system of claim 1, wherein the transceiver module is further configured for receiving the first configuration file of the terminal device.

13. A server for securely transmitting configuration files to a terminal device, the server comprising:
an encrypting module configured for retrieving and encrypting a configuration file;
a signing module configured for retrieving a sign private key and signing the encrypted configuration file with the sign private key; and
a transmitting module configured for transmitting the signed configuration file to the terminal device.

14. The server of claim 13, further comprising a configuration file storage module configured for storing the configuration files of the terminal device.

15. The server of claim 1 3, further comprising a certificate center for storing the sign private key.

16. The server of claim 13, wherein the signing module signs the encrypted configuration file according to an asymmetric algorithm.

17. The server of claim 13, wherein the encrypting module encrypts the configuration file with a random key according to a symmetric algorithm.

18. The server of claim 17, wherein the encrypting module is further configured for retrieving an encryption public key and encrypting the random key with the encryption public key according to an asymmetric algorithm, and inserting the encrypted random key into the encrypted configuration file.

19. A terminal device for securely downloading configuration files from a server, the terminal device comprising:
a downloading module configured for downloading a first configuration file of the terminal device from the server upon the condition that the terminal device is powered on, and activating the server to transmit a second configuration file of the terminal device, the first configuration file comprising a sign public key;
a transceiver module configured for receiving a signed second configuration file;
a verifying module configured for retrieving the sign public key from the first configuration file and verifying the signed second configuration file with the sign public key; and
a decrypting module configured for decrypting the verified second configuration file to retrieve the second configuration file.

20. The terminal device of claim 19, wherein the verified second configuration file comprises an encrypted second configuration file and an encrypted random key of a symmetric algorithm, and the decrypting module decrypts the encrypted random key in the verified second configuration file with an encryption private key according to an asymmetric algorithm to retrieve the random key, and decrypts the encrypted second configuration file in the verified second configuration file with the random key of the symmetric algorithm.
